(19) United States
(12) Patent Application Publication
(10) Pub. No.: US 2006/0159510 A1
(43) Pub. Date: Jul. 20, 2006

(54) Method and apparatus for dispensing liquid for skin application

(75) Inventors: Jung S. Moon, Buffalo Grove, IL (US); Rong Liu, Gurnee, IL (US); Jong Rok Kim, Seoul (KR)

Correspondence Address: GREER, BURNS & CRAIN, 300 S WACKER DR, 25TH FLOOR, CHICAGO, IL, 60606, US

(73) Assignee: Hearthware Home Products, Inc.

(21) Appl. No.: 11/038,352

(22) Filed: Jan. 18, 2005

(51) Int. Cl. A46B 11/02; A46B 5/02; B05C 17/005

(52) U.S. Cl. 401/190

(57) ABSTRACT

An apparatus for dispensing liquid for applying on the skin includes a housing, a generator provided in the housing for generating pressurized air, and an applicator in fluid communication with the generator for holding the liquid to be applied on the skin. A nozzle assembly is provided in the applicator for operatively nebulizing the liquid in the applicator in cooperation with the generator. The nebulized liquid flows out of the applicator and is applied on the skin.

### FIELD OF THE INVENTION

The present invention generally relates to liquid delivery devices and methods, and in particular, to delivery of nebulized liquid for applying on the skin.

### BACKGROUND OF THE INVENTION

Many devices for delivering liquid media such as, for example, hand lotion, shaving lotion, hair gel or spray, etc., to the skin or hair are known. Some hair care products, for example, are dispensed through aerosol cans and sprayed directly on the user's hair. In other known liquid delivery devices, an applicator pad is fashioned over the top of an aerosol can, and the product is first absorbed by the applicator pad before being applied on the skin.

For delivery of products such as skin care lotion or suntan/sunblock lotion, plastic bottle type dispensers with or without a manual pump are often employed. When using these types of dispensers, a small amount of lotion is dispensed on the palm or the finger of the user, and then applied by rubbing the lotion on the skin by hand. Applying lotion in this manner only covers the very top surface of the skin, but not necessarily the deeper layer of the skin, where the lotion is required to thoroughly moisturize or protect the skin. Rubbing lotion on the skin by hand also does not result in even application of the lotion. Consequently, some areas of the skin may not have received sufficient amount of lotion to obtain the benefit of the lotion, while other areas might have been applied with too much lotion, which may block the pores in the skin and contribute to skin problems.

### SUMMARY OF THE INVENTION

The present invention relates to an apparatus and method for dispensing liquid for applying on the skin. The apparatus includes a housing, a generator provided in the housing for generating pressurized air, and an applicator in fluid communication with the generator for holding the liquid to be applied on the skin. A nozzle assembly is provided in the applicator for operatively nebulizing the liquid in the applicator in cooperation with the generator. The nebulized liquid flows out of the applicator and is applied on the skin.

### BRIEF DESCRIPTION OF THE DRAWINGS

FIG. 1 is a perspective view of a liquid delivery apparatus in accordance with one embodiment of the present invention;

FIG. 2 is a plan view of the liquid delivery apparatus of FIG. 1, shown with an applicator stored in a storage compartment;

FIG. 3 is a sectional view of a nozzle assembly provided inside the applicator shown in FIG. 1 for nebulizing liquid; and

FIG. 4 is a top view of the nozzle assembly of FIG. 3.

### DETAILED DESCRIPTION OF THE PREFERRED EMBODIMENTS

The invention is directed to a device and a method for delivering liquid, particularly in the form of a lotion, for applying on the skin. The liquid is nebulized, i.e., or converted to fine spray, using pressurized air, and then applied on the skin. In this manner, the liquid is readily absorbed in the skin without the user having to rub it in by hand.

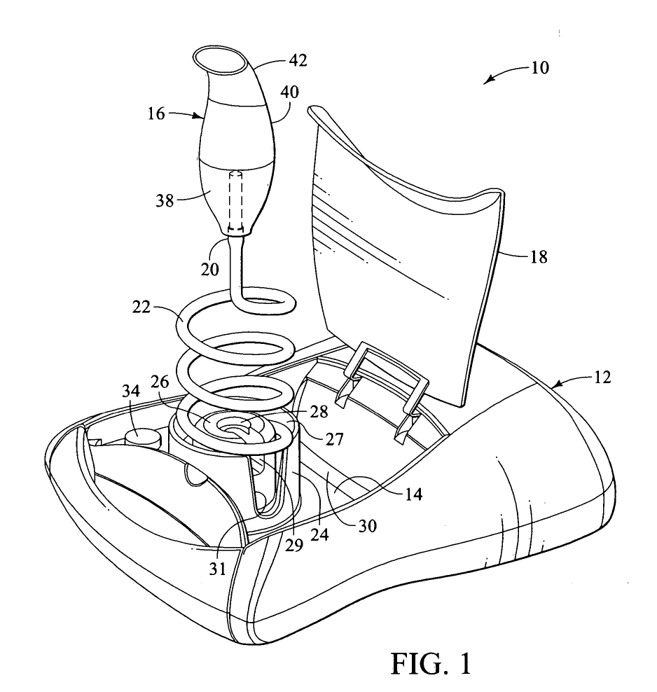

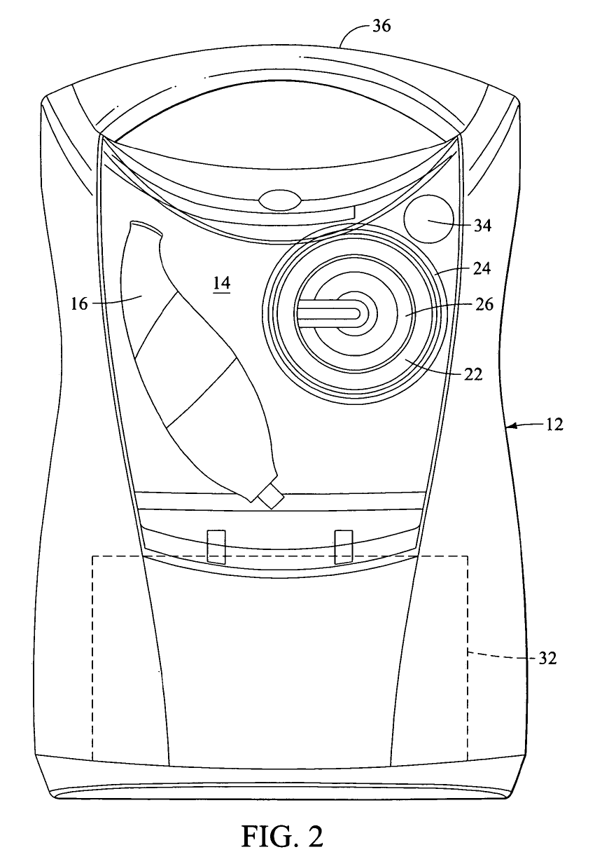

Turning now to FIG. 1, a liquid delivery apparatus 10 in accordance with one embodiment of the present invention includes a housing 12 having a storage compartment 14. An applicator 16 is configured and adapted to be stored in the storage compartment 14 (best show in FIG. 2). A hinged door 18 is attached to the edge of one side of the storage compartment 14, so that is opens (as shown in FIG. 1) and closes (as shown in FIG. 2) to allow access to the applicator 16 stored in the storage compartment 14.

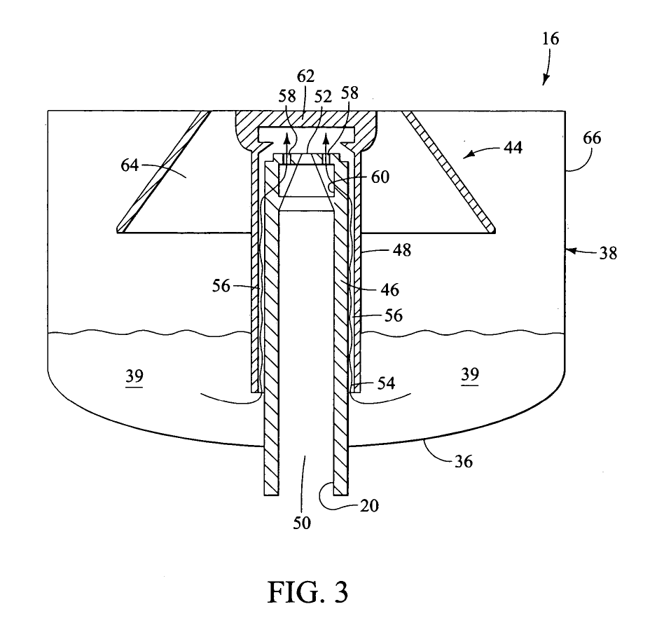

The applicator 16 includes an inlet opening 20 (best shown in FIG. 3), which is connected to one end of a flexible and coiled hose 22. When in its coiled state, the hose 22 is configured to be retracted into a generally cylindrical sleeve 24, which projects from the floor of the storage compartment 14. An applicator stand 26 also projects from the floor of the storage compartment 14 inside the sleeve 24, so that it is generally concentric and spaced from the cylindrical sleeve 24 to define an annular chamber 27 between the stand and the sleeve. The applicator stand 26 also includes a generally circular hole 28 at the top thereof to allow a user to place the applicator 16 in the hole in an upright or generally vertical position, so that the user is able to set the applicator down. A slit 29 is formed on the side of the stand 26 and connects with the hole 28 to allow the hose 22 near the inlet opening 20 of the applicator 16 to extend inside the stand 26 and remain connected to the applicator 16. When the applicator 16 is placed in the stand 26, the hose 22 fits into annular chamber 27 in the coiled form.

When the applicator 16 is placed in the stand 26, the storage compartment door 18 is adapted to be left open, as shown in FIG. 1. However, the storage compartment 14 also has a space 30 surrounding the sleeve 24 where the applicator 16 may be stored so that the compartment door 18 can be closed. When stored in this manner, with the storage compartment door 18 closed, the hose 22 is also stored in the sleeve chamber 27. The sleeve 24 also has a slit 31 which enables the portion of the hose 22 near the applicator 16 to come out of the chamber 27 on the side (and not from the top), so as to provide a more neat appearance. The sleeve 24 and the stand 26 are made of light weight substantially rigid plastic to retain their form and to provide support for the applicator 16 and the hose 22.

As shown in phantom lines in FIG. 2, the liquid delivery apparatus 10 also includes a compressor 32 provided inside the housing 12 for generating pressurized air. It should be understood that pressurized air can be supplied by other suitable sources such as, for example, an air pump or a compressed air cartridge or canister. The compressor 32 is connected to the hose 22 at the opposite end (not shown) from the end that is connected to the applicator 16, and is electrically connected to a switch 34 for switching the compressor 32 ON and OFF. Accordingly, the compressor 32 is connected to an AC or DC power source (not shown). A handle 36 is provided at the top of the housing 12 at the opposite end from where the compressor 32 is provided.

Referring back to FIG. 1, the liquid applicator 16 includes a reservoir 38 where the liquid such as in the form of lotion 39 (shown in FIG. 3) to be applied to the skin is held. The applicator 16 also includes a generally tubular passageway 40, which at its bottom end is configured to be removably attached to the reservoir 38. On the opposite end of the passageway 40, a directional outlet 42 is removable attached to the passageway 40. The directional outlet 42 has an opening which is at some angle relative to the longitudinal length of the passageway 40, not quite 90 degrees, so that the outlet can be exposed to the skin more comfortably by the user, without having to hold the applicator 16 vertically against the skin surface. It should be understood that the directional outlet 42 need not be at an angle, nor be a separate piece from the passageway 40. Rather, the directional outlet 42 may be an extended portion of the passageway 40.

The storage compartment door 18 in one embodiment is translucent. However, it may be made from any relatively rigid lightweight plastic material. The hose 22 is formed from a relatively hard and clear or translucent plastic, which is molded to retain its coiled shape when the lotion applicator 16 is placed on the applicator stand 26 or in the storage compartment 14. The hose is stretched to an extended coil shape when the applicator 16 is pulled out of the storage compartment 14 and being used.

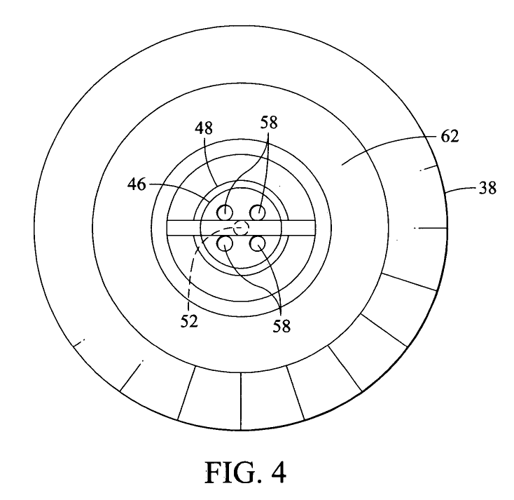

Turning now to FIGS. 3 and 4, a nozzle assembly 44 is shown inside the reservoir 38 of the applicator 16. The nozzle assembly 44 includes a stationary inner tube 46 and a removable outer tube 48. The inner tube 46 includes an air passage 50 that extends from the inlet opening 20 at the bottom of the reservoir 38 to an air outlet 52 at the opposite end of the air passage. The inner tube 46 fits concentrically into a passageway 54 of the outer tube 48. As shown in FIG. 3, the outer tube 48 is somewhat shorter than the inner tube 46 so that when the outer tube is placed over the inner tube, the outer tube does not extend all the way to the bottom of the reservoir 38.

When the outer tube 48 is placed over the inner tube 46, an intermediate passage 56 is formed between the inner tube and the outer tube. The intermediate passage 56 serves to convey liquid from the bottom of the reservoir 38 to four ejection holes 58 provided at the top of the inner tube 46 (best shown in FIG. 4). The inner tube 46 includes two windows 60 generally on the opposite sides of the tube which are open to the intermediate passage 56 to enable fluid communication between the intermediate passage and the ejection ports 58.

The nozzle assembly 44 further includes a stopper 62 which has two ends that are attached to the opposite sides of the top of the outer tube 48. When the outer tube 48 is placed over the inner tube 46, the stopper 62 is positioned substantially directly over the air outlet 52 of the inner tube 46. The nozzle assembly 44 further includes an annular deflector 64 which is attached to the two ends of the stopper 62, and extends downwardly at an angle away from the outer tube 48 to approximately half way between the outer tube and the outer wall 66 of the reservoir 38. The deflector 64 serves to impede large droplets of liquid 39 that might form and carried out of the reservoir 38.

In operation, liquid 39 is filled to a desired level in the reservoir 38 of the applicator 16, and the passageway 40 is attached to the reservoir. When the passageway 40 is attached to the reservoir 38, the stopper 62 is positioned directly over and spaced slightly from the air outlet 52 of the inner tube 46. In this manner, when pressurized air is supplied through the inner tube 46 from the compressor 32, via the air hose 22, gas is expelled out the air outlet 52 and diverted by the stopper 62 away from the air outlet 52 and deflected downwardly by the deflector 64. This creates a negative pressure over the ejection ports 58, thereby drawing the liquid 39 in the bottom of the reservoir 38 through the intermediate passage 56 and then out the ejection ports. The liquid 39 at this point is entrained into the escaping gas and is nebulized, i.e., converted into a fine spray or vapor. The nebulized liquid then flows through the passageway 40 of the applicator 16 and out the directional outlet 42, which is held over the skin. The nebulized liquid exiting the applicator 16 is then absorbed through the surface of the skin. The present invention is particularly adopted to be used in applying skin care lotion on the skin.

While a specific embodiment of the present invention has been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An apparatus for dispensing liquid for applying on the skin, comprising:
a housing;
a generator provided in said housing for generating pressurized air;
an applicator in fluid communication with said generator for holding the liquid to be applied on the skin; and
a nozzle assembly provided in said applicator for operatively nebulizing the liquid in the applicator in cooperation with said generator;
wherein said nebulized liquid flows out of said applicator and applied on the skin.

2. The apparatus as defined in claim 1, wherein said generator is an air compressor.

3. The apparatus as defined in claim 2, further comprising a hose connected between said generator and said applicator for providing said fluid communication therebetween.

4. The apparatus as defined in claim 1 wherein said housing includes a storage area, and said applicator is configured and adapted to be stored in said storage area.

5. The apparatus as defined in claim 4, further including a stand provided in said storage area and configured and adapted to have said applicator placed thereon.

6. The apparatus as defined in claim 5, further including a sleeve formed concentrically around said stand to form an annular chamber, and a hose connected between said generator and said applicator for providing said fluid communication therebetween, wherein said hose is configured and adapted to be stored in said annular chamber.

7. The apparatus as defined in claim 6, wherein said applicator is placed in said stand at its bottom end so that said applicator extends generally vertically out of said storage area.

8. The apparatus as defined in claim 7, wherein said stand and said sleeve each have a slit extending down its sides to enable said hose to extend therethrough.

9. The apparatus as defined in claim 4 further comprising a cover adapted to open and close over said storage area.

10. The apparatus as defined in claim 1, wherein the liquid is in the form of a lotion.

11. The apparatus as defined in claim 1 further comprising a handle attached to the housing.

12. The apparatus as defined in claim 2, further including a switch for turning said air compressor on and off.

13. The apparatus as defined in claim 1, wherein said nozzle assembly is configured and adapted entrain droplets of the liquid into the pressurized air.

14. A method for applying liquid on the skin, comprising;
holding the liquid to be applied on the skin in an applicator;
nebulizing the liquid in the applicator using pressurized air; and
dispensing the nebulized liquid from the applicator on the skin.

15. The method as described in claim 14, wherein the liquid is a lotion.

16. The method as described in claim 14, wherein the applicator is operatively connected by a hose to an air compressor for generating the pressurized air.

17. The method as defined in claim 16, wherein the liquid is nebulized in the applicator by a nozzle assembly which entrains drops of the liquid into the pressurized air.
